(19) United States
(12) Patent Application Publication
(10) Pub. No.: US 2022/0147327 A1
(43) Pub. Date: May 12, 2022

(54) Method and Computer Program for Generating Menu Model of a Character User Interface

(71) Applicant: TMAXSOFT CO., LTD., Gyeonggi-do (KR)

(72) Inventors: Yeongha LEE, Gyeonggi-do (KR); Youngjae LEE, Gyeonggi-do (KR)

(73) Assignee: TMAXSOFT CO., LTD., Gyeonggi-do (KR)

(21) Appl. No.: 17/494,130

(22) Filed: Oct. 5, 2021

(30) Foreign Application Priority Data
Nov. 11, 2020 (KR) 10-2020-0150421

(51) Int. Cl. G06F 8/38; G06F 3/0482; G06F 9/451

(52) U.S. Cl. CPC G06F 8/38; G06F 9/451; G06F 3/0482

(57) ABSTRACT

Disclosed is a method for generating a menu model of a character user interface. The method may include: recognizing one or more reference variables into which one or more objects are input among one or more variables related to a first screen; generating call relationship information of each of the one or more reference variables; recognizing a common reference variable which is commonly referenced among the one or more reference variables by using the call relationship information; and generating a menu model by using at least one menu selection variable included in the common reference variable.

### CROSS-REFERENCE TO RELATED APPLICATIONS

This application claims priority to and the benefit of Korean Patent Application No. 10-2020-0150421 filed in the Korean Intellectual Property Office on Nov. 11, 2020, the entire contents of which are incorporated herein by reference.

### TECHNICAL FIELD

The present disclosure relates to a method and a computer program for generating a menu model of a character user interface, and more particularly, to a method and a computer program for generating a menu model by using a code related to a menu in a program code prepared based on a character user interface.

### BACKGROUND ART

A character user interface (legacy program) of a main frame in related art performs menu selection based on typing. In the case of such a character user interface of the main frame, a screen design and a program code are complicatedly entangled, so it is difficult even to separate menu logic and program logic.

Meanwhile, a web environment based user interface which is currently used provides a menu selection function using a mouse click or a touch. However, when the character user interface of the main frame is switched to a web environment due to complexity of the program code, it is difficult to switch to a user convenience based menu. In this case, even though a user switches a program of a main frame environment to the web environment and uses the web environment, the menu selection through the mouse click or touch is impossible, the user cannot feel like using a web.

Accordingly, there is a need for research and development of a technology that converts a typing based menu selection function a mouse click based menu selection function.

### SUMMARY OF THE INVENTION

The present disclosure has been made in an effort to provide a method and a computer program for generating a menu model of a character user interface.

However, technical objects of the present disclosure are not restricted to the technical object mentioned as above. Other unmentioned technical objects will be apparently appreciated by those skilled in the art by referencing to the following description.

Disclosed is a method for generating a menu model of a character user interface. The method may include: recognizing one or more reference variables into which one or more objects are input among one or more variables related to a first screen; generating call relationship information of each of the one or more reference variables; recognizing a common reference variable which is commonly referenced among the one or more reference variables by using the call relationship information; and generating a menu model by using at least one menu selection variable included in the common reference variable.

Further, the recognizing of one or more reference variables into which one or more objects are input among one or more variables related to the first screen may include recognizing the one or more variables related to the first screen, and recognizing a variable changeable through user input among the one or more variables related to the first screen as the at least one reference variable.

The generating of the call relationship information of each of the one or more reference variables may include recognizing a second screen switched when a first object is input into a first reference variable related to the first screen, and generating the call relationship information including a graph showing a call relationship of the first reference variable, the first object, and the second screen.

The generating of the call relationship information of each of the one or more reference variables may include recognizing a first program executed when the first object is input into the first reference variable related to the first screen, and generating the call relationship information including a graph showing a call relationship of the first reference variable, the first object, and the first program.

The recognizing of the common reference variable which is commonly referenced among the one or more reference variables by using the call relationship information may include when each of two or more objects is input into the first reference variable related to the first screen, recognizing whether each input object is switched to each of two or more screens corresponding to two or more objects, respectively, and when each of two or more objects is input into the first reference variable, if it is recognized that each input object is switched to each of two or more screens corresponding to two or more objects, respectively, recognizing the first reference variable as the common reference variable.

The generating of the menu model by using at least one menu selection variable included in the common reference variable may include when each of a predetermined number or more objects is input into the first reference variable recognized as the common reference variable, recognizing whether each input object is switched to each of a predetermined number or more screens corresponding to a predetermined number or more objects, respectively, and when each of the predetermined number or more objects is input into the first reference variable, if it is recognized that each input object is switched to each of the predetermined number or more screens corresponding to the predetermined number or more objects, respectively, determining the first reference variable as the menu selection variable.

The generating of the menu model by using at least one menu selection variable included in the common reference variable may include when the at least one object is input into the at least one menu selection variable, recognizing at least one switched final screen or at least one executed final program, and generating the menu model by mapping at least one menu selection variable and at least one object, and information on the at least one final screen or information on the at least one final program.

The method may further include: recognizing at least one word on a screen related to the at least one menu selection variable; recognizing a similarity value between the at least one word and the at least one object; determining a first word having a largest similarity value for a first object among one or more objects as a menu description word of the first object; and mapping the first object and the menu description word when generating the menu model.

The generating of the menu model by using at least one menu selection variable included in the common reference variable may include when the at least one object is input into the at least one menu selection variable, recognizing whether a subsequent operation related to the at least one object is determined by a server, and when the subsequent operation related to the at least one object is determined by the server, generating the menu model by using the menu selection variable and information on the subsequent operation related to the at least one object.

When the subsequent operation related to the at least one object is determined by the server, the generating of the menu model by using the menu selection variable and the information on the subsequent operation related to the at least one object may include when the subsequent operation related to the at least one object corresponds to the at least one object, generating the menu model by mapping the at least one menu selection variable, the at least one object, and the information on the subsequent operation corresponding to the at least one object.

The information on the subsequent operation corresponding to the at least one object may include when the at least one object is input into the at least one menu selection variable, at least one of the information on at least one switched final screen or the information on at least one executed final program.

When the subsequent operation related to the at least one object is determined by the server, the generating of the menu model by using the menu selection variable and the information on the subsequent operation related to the at least one object may include when the subsequent operation related to the at least one object does not correspond to the at least one object, generating the menu model by mapping the at least one menu selection variable, the at least one object, and the information on an operation of transmitting the at least one object to the server.

An exemplary embodiment of the present disclosure provides a computer program stored in a computer readable storage medium. The computer program may include commands which cause a processor of a computing device for generating a menu model to perform the following steps and the steps may include: recognizing at least one reference variable into which at least one object is input among one or more variables related to a first screen; generating call relationship information of each of the one or more reference variables; recognizing a common reference variable which is commonly referenced among the one or more reference variables by using the call relationship information; and generating a menu model by using at least one menu selection variable included in the common reference variable.

Technical solving means which can be obtained in the present disclosure are not limited to the aforementioned solving means and other unmentioned solving means will be clearly understood by those skilled in the art from the following description.

According to an exemplary embodiment of the present disclosure, a method and a computer program for generating a menu model which can easily convert a character user interface developed based on a main frame environment into a web environment can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a computing device generating a menu model of a character user interface according to some exemplary embodiments of the present disclosure.

FIG. 2 is a flowchart for describing a method for generating a menu model of a character user interface according to some exemplary embodiments of the present disclosure.

FIG. 3 is a flowchart for describing an example of a method for generating a menu model according to some exemplary embodiments of the present disclosure.

FIG. 4 is a flowchart for describing another example of a method for generating a menu model according to some exemplary embodiments of the present disclosure.

FIG. 5 is a diagram for describing an example of at least one variable included in a character user interface screen according to some exemplary embodiments of the present disclosure.

FIG. 6 is a diagram for describing an example of a graph showing a call relationship according to some exemplary embodiments of the present disclosure.

FIG. 7 is a diagram for describing an example of a method for determining a menu selection variable in a program code related to a character user interface according to some exemplary embodiments of the present disclosure.

FIG. 8 is a diagram for describing an example of a menu model according to some exemplary embodiments of the present disclosure.

FIG. 9 illustrates a simple and general schematic view of an exemplary computing environment in which the exemplary embodiments of the present disclosure may be implemented.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Various aspects and features will be presented by a system which can include one or more apparatuses, terminals, servers, devices, components, and/or modules. It should also be appreciated and recognized that various systems can include additional apparatuses, terminals, servers, devices, components, and/or modules and/or that the various systems cannot include all of apparatuses, terminals, servers, devices, components, modules, and the like discussed in association with the drawings.

“Computer program”, “component”, “module”, “system”, and the like which are terms used in this specification may be used to be compatible with each other and refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers.

The components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Hereinafter, like reference numerals refer to like or similar elements regardless of reference numerals and a duplicated description thereof will be omitted. Further, in describing an embodiment disclosed in the present disclosure, a detailed description of related known technologies will be omitted if it is determined that the detailed description makes the gist of the embodiment of the present disclosure unclear. Further, the accompanying drawings are only for easily understanding the exemplary embodiment disclosed in this specification and the technical spirit disclosed by this specification is not limited by the accompanying drawings.

The terminology used in this specification is for the purpose of describing embodiments only and is not intended to limit the present disclosure. In this specification, the singular form also includes the plural form, unless the context indicates otherwise. It is to be understood that the terms “comprise” and/or “comprising” used in the specification does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

The terms “information” and “data” used in the specification may also be often used to be exchanged with each other.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

The scope of the operations in the claims of the present disclosure arises from the functions and features described in respective steps, and is not affected by the order in which respective steps in the claims are disclosed if a sequence relationship of the disclosed order in respective steps constituting the method is not specified. For example, in the claims set forth in the step including steps A and B, the scope of rights is not limited to the fact that step A precedes step B, even if step A is described before step B.

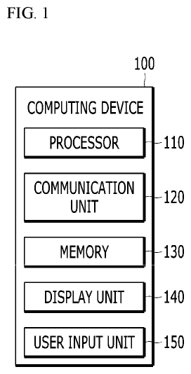

FIG. 1 is a block diagram of a computing device generating a menu model of a character user interface according to some exemplary embodiments of the present disclosure.

Referring to FIG. 1, a computing device 100 may include a processor 110, a communication unit 120, a memory 130, a display unit 140, and a user input unit 150. However, components described above are not required in implementing the computing device 100, so the computing device 100 may have components more or less than components listed above.

The computing device 100 may include a predetermined type computer system or computer device such as a microprocessor, a main frame computer, a digital processor, a portable device, and a device controller. Further, the computing device 100 may mean a client which is a computer directly used by the user. However, the present disclosure is not limited thereto.

The processor 110 of the computing device 100 generally controls an overall operation of the computing device 100. The processor 110 processes a signal, data, information, and the like input or output through the components included in the computing device 100 or drives the application program stored in the memory 130 to provide or process information or a function appropriate for the user.

The processor 110 may control at least some of the components of the computing device 100 in order to drive the application program stored in the memory 130. Furthermore, the processor 110 may combine and operate at least two of the components included in the computing device 100 in order to drive the application program.

According to some exemplary embodiments of the present disclosure, the processor 110 of the computing device 100 may recognize one or more reference variables among one or more variables related to a character user interface screen. Further, the processor 110 may generate call relationship information of each of one or more reference variables. Further, the processor 110 may recognize a common reference variable which is commonly referenced among one or more reference variables by using the call relationship information. In addition, the processor 110 may generate a menu model by using at least one menu selection variable included in the common reference variable. Here, the reference variable may mean a variable to which at least one object is substituted. Further, at least one object may mean an object which the user inputs into the reference variable or an object which the processor 110 inputs into the reference variable. However, the present disclosure is not limited thereto.

The menu model according to some exemplary embodiments of the present disclosure may be a model to which a specific menu selection variable, a specific object input into the specific menu selection variable, and a specific operation (e.g., a switched screen or an executed program) executed when the specific object is input into the specific menu selection variable are mapped. For example, the menu model may be a table type model to which each of the specific menu selection variable, the specific object, and the specific operation is mapped. However, the present disclosure is not limited thereto.

The menu model of the present disclosure may be used for converting a menu function generated based on a main frame environment into a menu function usable in a web environment. For example, the menu model may be used for converting a typing based menu selection function (main frame environment) into a click based menu selection function or a list based menu selection function (web environment). However, the present disclosure is not limited thereto.

Accordingly, the menu model of the present disclosure may increase productivity of a menu switching operation between different program environments.

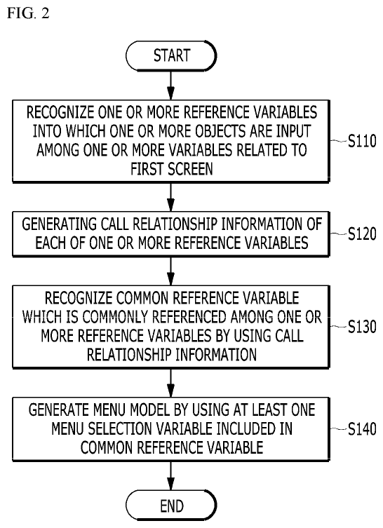

Hereinafter, a method for generating the menu model by the computing device 100 according to the present disclosure will be described below with reference to FIGS. 2 to 8.

Meanwhile, the communication unit 120 of the computing device 100 may include one or more modules which enable communication between the computing device 100 and a user terminal and between the computing device 100 and servers. In addition, the communication unit 120 may include one or more modules that connect the computing device 100 to one or more networks.

A network which connects communication between the computing device 100 and the user terminal and between the computing device 100 and the servers may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network presented here may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

The network according to the exemplary embodiments of the present disclosure may be configured regardless of communication modes such as wired and wireless modes and constituted by various communication networks including a local area network (LAN), a wide area network (WAN), and the like. Further, the network may be known World Wide Web (WWW) and may adopt a wireless transmission technology used for short-distance communication, such as infrared data association (IrDA) or Bluetooth.

The techniques described in this specification may also be used in other networks in addition to the aforementioned networks.

The memory 130 of the computing device 100 may store a program for an operation of the processor 110 and temporarily or persistently store input/output data. The memory 130 may include at least one type of storage medium of a flash memory type, a hard disk type, a multimedia card micro type, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The memory 130 may be operated by the control by the processor 110.

According to software implementation, embodiments such as a procedure and a function described in the specification may be implemented by separate software modules. Each of the software modules may perform one or more functions and operations described in the specification. A software code may be implemented by a software application written by an appropriate program language. The software code may be stored in the memory 130 of the computing device 100 and executed by the processor 110 of the computing device 100.

The display unit 140 of the computing device 100 displays (outputs) information processed in the computing device 100. For example, the display unit 140 may display execution screen information of an application program driven by the computing device 100 or user interface (UI) information and graphic user interface (GUI) information depending on the execution screen information.

The display unit 140 according to some exemplary embodiments of the present disclosure may output a main frame environment based character user interface or a web environment based user interface. However, the present disclosure is not limited thereto.

The user input unit 150 of the computing device 100 is used for receiving information from the user, and when the information is input through the user input unit 150, the processor 110 may control an operation of the computing device 100 to correspond to the input information. The user input unit 150 may include a mechanical input means and a touch type input means. For example, the touch type input means may be constituted by a virtual key, a soft key, or a visual key displayed in a touch screen (i.e., the display unit 140) through software processing or constituted by a touch key disposed in a portion other than the touch screen, while the virtual key or the visual key may be displayed on the touch screen while showing various forms, and for example, may be configured by graphic, text, icon, video, or a combination thereof.

The user input unit 150 may include pointing devices such as a keyboard and a mouse. The user may input a command or information into the computing device 100 through the pointing devices such as the keyboard and the mouse. Additionally, the user input unit 150 may include other input devices (e.g., a microphone, an IR remote controller, a joystick, a game pad, and a stylus pen).

The user input unit 150 according to some exemplary embodiments of the present disclosure may receive an input for a menu selection related to a character user interface or a user interface from the user. However, the present disclosure is not limited thereto.

FIG. 2 is a flowchart for describing a method for generating a menu model of a character user interface according to some exemplary embodiments of the present disclosure.

Referring to FIG. 2, the processor 110 of the computing device 100 may recognize at least one reference variable into which at least one object is input among one or more variables related to a first screen (S110). Here, the first screen may mean a screen of the character user interface. However, the present disclosure is not limited thereto.

Specifically, the processor 110 may recognize one or more variables related to the first screen. In addition, the processor 110 may recognize a variable changeable through a user input among one or more variables related to the first screen as at least one reference variable.

For example, the processor 110 may recognize one or more variables by analyzing a program code (or a source code) related to the first screen. As a detailed example, the processor 110 may recognize one or more variables by recognizing a naming feature, an annotation, or a tag related to a variable in a program code related to the first screen. However, the present disclosure is not limited thereto.

As another example, the processor 110 may recognize at least one variable by recognizing texts displayed in the first screen. As a detailed example, the processor 110 may extract at least one word by recognizing the texts displayed in the first screen. In addition, the processor 110 may recognize at least one variable by comparing words (e.g., words defined as variables) prestored in the memory 130.

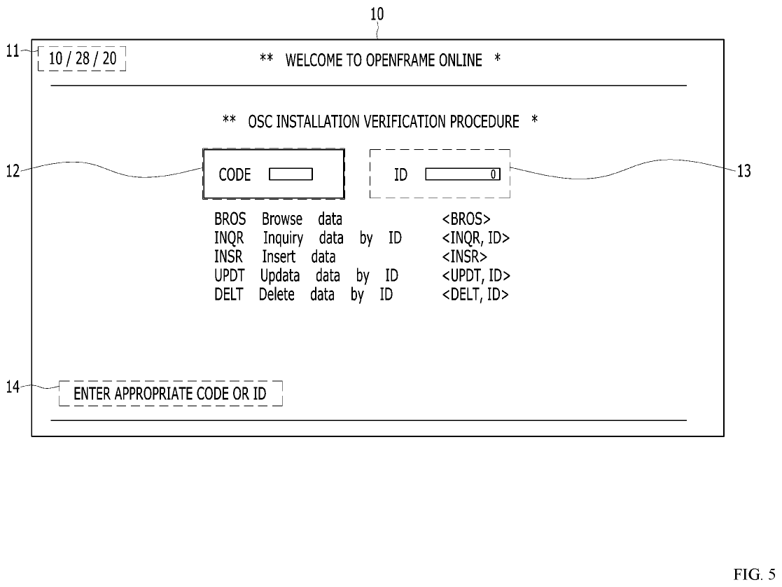

Hereinafter, at least one variable related to the first screen will be described below with reference to FIG. 5.

The processor 110 of the computing device 100 may recognize at least one reference variable, and then generate call relationship information of each of the one or more reference variables (S120). Here, the call relationship information may be information on a subsequent operation (e.g., a switched screen or an executed program) executed when a specific object is input into each of one or more reference variables. However, the present disclosure is not limited thereto.

Specifically, the processor 110 may generate the call relationship information by recognizing a subsequent screen (or program) converted when the specific object is input into a specific reference variable related to the first screen which is the character user interface screen.

As an example, the processor 110 may recognize a second screen switched when a first object is input into a first reference variable related to the first screen. In addition, the processor 110 may generate call relationship information including a graph showing a call relationship of the first reference variable, the first object, and the second screen.

As another example, the processor 110 may recognize a first program executed when the first object is input into the first reference variable related to the first screen. In addition, the processor 110 may generate call relationship information including a graph showing a call relationship of the first reference variable, the first object, and the first program.

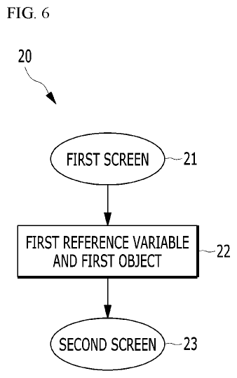

Hereinafter, the call relationship information will be described below with reference to FIG. 6.

The processor 110 of the computing device 100 may generate the call relationship information, and then recognize a common reference variable which is commonly referenced among one or more reference variables by using the call relationship information (S130).

Specifically, the processor 110 may recognize the common reference variable by recognizing a subsequent screen (or program) converted when each of two or more specific objects is input into the specific reference variable related to the first screen which is the character user interface screen.

More specifically, when each of two or more objects is input into the first reference variable related to the first screen, the processor 110 may recognize whether each input object is switched to each of two or more screens corresponding to two or more objects, respectively. In addition, when each of two or more objects is input into the first reference variable, if the processor 110 recognizes that each input object is switched to each of two or more screens corresponding to two or more objects, respectively, the processor 110 may recognize the first reference variable as the common reference variable.

When the processor 110 of the computing device 100 recognizes the common reference variable, the processor 110 of the computing device 100 may generate the menu model by using at least one menu selection variable included in the common reference variable (S140).

The menu model according to some exemplary embodiments of the present disclosure may be a model to which a specific menu selection variable, a specific object input into the specific menu selection variable, and a specific operation (e.g., a switched screen or an executed program) executed when the specific object is input into the specific menu selection variable are mapped. For example, the menu model may be a table type model to which each of the specific menu selection variable, the specific object, and the specific operation is mapped. However, the present disclosure is not limited thereto.

The character user interface (legacy program) of the main frame environment performs menu selection based on typing. In the case of such a character user interface of the main frame, a screen design and a program code are complicatedly entangled, so it is difficult even to separate menu logic and program logic. As a result, even though the character user interface of the main frame environment is converted into the web environment, the menu selection function through the typing is provided.

The computing device 100 of the present disclosure may generate the menu model by extracting menu logic from the character user interface of the main frame environment through the processor disclosed in the present disclosure. Specifically, the menu model generated by the computing device 100 may be used for converting a menu function generated based on the main frame environment into a menu function usable in a web environment. Specifically, the menu model may be used for converting a typing based menu selection function (main frame environment) into a click based menu selection function or a list based menu selection function (web environment).

For example, the menu model may be used as a source in a program for generating the menu in the web environment. As a detailed example, the menu model may provide a function to, when clicking on a template desired by the user in an integrated development environment (IDE) related to generation of the menu in the web environment, generate the resulting menu. That is, the user may implement the menu function of the web environment in a form to cover a design to the menu of the main frame environment in the related art by using the menu model and the IDE.

Accordingly, the menu model of the present disclosure may increase productivity of a menu switching operation between different program environments.

Meanwhile, the processor 110 of the computing device 100 may determine at least one menu selection variable among the common reference variables before generating the menu model.

Specifically, when each of a predetermined number (e.g., 3) or more objects is input into the first reference variable recognized as the common reference variable, the processor 110 may recognize whether each input object is switched to each of a predetermined number or more screens corresponding to a predetermined number or more objects, respectively. In addition, when each of the predetermined number or more objects is input into the first reference variable, if the processor 110 recognizes that each input object is switched to each of the predetermined number or more screens corresponding to the predetermined number or more objects, respectively, the processor 110 may determine the first reference variable as the menu selection variable. However, the present disclosure is not limited thereto.

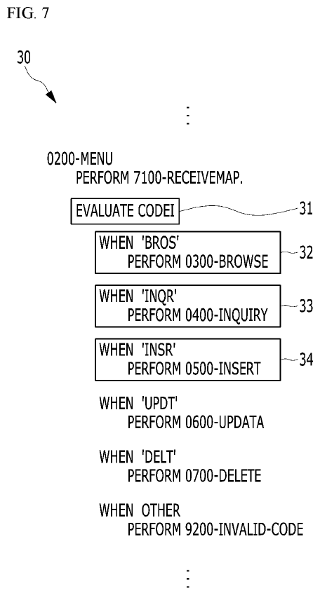

Hereinafter, the menu selection variable of the present disclosure will be described below with reference to FIG. 7.

Meanwhile, the processor 110 of the computing device 100 may determine the menu selection variable, and then generate the menu model by using the menu selection variable.

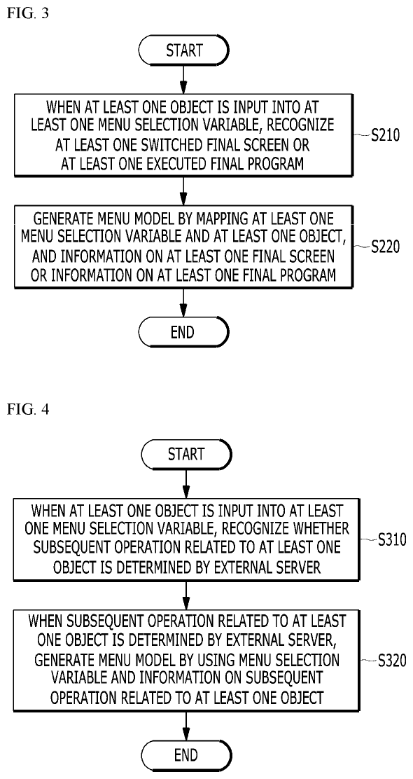

Hereinafter, a specific method for generating the menu model by using the menu selection variable by the computing device 100 according to the present disclosure will be described with reference to FIGS. 3 and 4.

FIG. 3 is a flowchart for describing an example of a method for generating a menu model according to some exemplary embodiments of the present disclosure.

According to some exemplary embodiments of the present disclosure, the computing device 100 may generate a menu model that may switch a menu function generated based on various mainframe environments into the web environment.

For example, the processor 110 of the computing device 100 may generate a menu model that may switch a menu function of ‘Interactive System Productivity Facility (ISPF)’ which is a software product for a z/OS operating system executed in an IBM mainframe into the web environment. However, the present disclosure is not limited thereto.

Referring to FIG. 3, when at least one object is input into at least one menu selection variable, the processor 110 of the computing device 100 may recognize at least one switched final screen or at least one executed final program (S210).

The processor 110 may generate a menu model by mapping at least one menu selection variable and at least one object, and information on at least one final screen or information on at least one final program (S220).

Here, the processor 110 may additionally recognize at least one word in a screen related to at least one menu selection variable. Further, the processor 110 may recognize a similarity value between at least one word and at least one object. Further, the processor 110 may determine a first word having a largest similarity value for a first object among one or more objects as a menu description word of the first object. In this case, the processor 110 may map the first object and the menu description word when generating the menu model in the above-described step (S220).

Accordingly, the user may easily switch the menu generated based on the main frame by using the menu model of the present disclosure into the menu usable in the web environment.

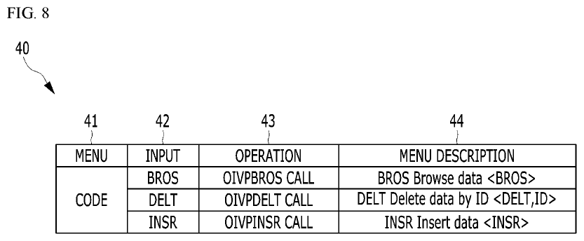

Hereinafter, the menu model of the present disclosure will be described below with reference to FIG. 8.

FIG. 4 is a flowchart for describing another example of a method for generating a menu model according to some exemplary embodiments of the present disclosure.

According to some exemplary embodiments of the present disclosure, the computing device 100 may generate a menu model that may switch a menu function generated based on various mainframe environments into the web environment.

For example, the processor 110 of the computing device 100 may generate a menu model that may switch a menu function of ‘Customer Information Control System (CICS)’ which is a transaction server primarily driven in the IBM mainframe system using the z/OS and a z/VSE operating system into the web environment. However, the present disclosure is not limited thereto.

Referring to FIG. 4, when at least one object is input into at least one menu selection variable, the processor 110 of the computing device 100 may recognize whether a subsequent operation (e.g., a switched screen or an executed program) related to at least object is determined by the server (S310).

Specifically, when at least one object is input into at least one menu variable, the processor 110 of the computing device 100 may recognize whether the at least one menu variable or the at least one object is transmitted to the server. Further, the processor 110 may recognize whether to receive information on the subsequent operation related to the at least one object from the server. In addition, when the at least one menu variable or the at least one object is transmitted to the server, and the information on the subsequent operation related to the at least one object is received, the processor 110 may recognize that the subsequent operation related to at least one object is determined by the server.

Here, when at least one object is input into at least one menu selection variable according to an environment of a program providing the menu function, the subsequent operation related to at least one object may be determined by the server. For example, when at least one object is input into at least one menu selection variable according to a CICS environment, the subsequent operation related to at least one object may be determined by the server. Here, the server that determines the subsequent operation may be a server driven in the main frame system, for example. However, the present disclosure is not limited thereto.

Meanwhile, when the subsequent operation related to at least one object is determined by the server, the processor 110 of the computing device 100 may generate a menu model by using information on a subsequent operation related to the menu selection variable and at least one object (S320).

As an example, when the subsequent operation related to at least one object corresponds to at least one object, the processor 110 may generate the menu model by mapping at least one menu selection variable, at least one object, and information on the subsequent operation corresponding to at least one object. Here, when at least one object is input into at least one menu selection variable, the information on the subsequent operation corresponding to at least one object may include at least one of information on at least one switched final screen or information on at least one executed final program. However, the present disclosure is not limited thereto.

Here, the information on the final screen may be information related to a screen finally shown to the user when at least one object is input into at least one menu selection variable. For example, the final screen information may include data for switching to a screen corresponding to at least one object or an address of a screen corresponding to at least one object prestored in the memory 130. However, the present disclosure is not limited thereto.

The information on the final program may be information related to a program finally shown the user to be executed when at least one object is input into at least one menu selection variable. For example, the information on the final program may include data for executing a program corresponding to at least one object or an address of a program corresponding to at least one object prestored in the memory 130. However, the present disclosure is not limited thereto.

According to some exemplary embodiments of the present disclosure, when the user presses a specific button generated through the menu model (i.e., menu selection), a program corresponding to the specific button may be immediately executed without passing through the server or a screen corresponding to the specific button may be displayed.

That is, the computing device 100 of the present disclosure may generate the menu model by mapping a user input and a code for analyzing the user input. In this case, when the user performs the user input, the user may read the screen corresponding to the user input or execute the program.

For example, when the user presses a first button in the menu generated through the menu model of the present disclosure (i.e., when clicking on or touching the first button), a first screen corresponding to the first button may be displayed or a first program corresponding to the first button may be executed.

As another example, when the subsequent operation related to at least one object does not correspond to at least one object, the processor 110 may generate the menu model by mapping at least one menu selection variable, at least one object, and information on an operation of transmitting at least one object to the server. However, the present disclosure is not limited thereto.

As described above, when at least one object is input into at least one menu selection variable according to an environment of a program providing the menu function, the subsequent operation related to at least one object may be determined by the server.

Here, the server may perform an additional operation by using at least one object (e.g., using at least one object as an input value into a specific function), and then determine the subsequent operation by using a result value thereof. Accordingly, the subsequent operation related to at least one object may not correspond to the at least one object.

In this case, when at least one object is input into at least one menu selection variable, it is difficult to specify information on at least one switched final screen or information on at least one executed final program. Accordingly, the processor 110 of the present disclosure may generate the menu model by mapping the information on the operation of transmitting at least one object to the server and at least one menu selection variable and at least one object in order to obtain the information on the subsequent operation from the server when generating the menu model.

The menu model according to the present disclosure may increase productivity of a menu switching operation between different program environments.

Hereinafter, the menu model of the present disclosure will be described below with reference to FIG. 8.

FIG. 5 is a diagram for describing an example of at least one variable included in a character user interface screen according to some exemplary embodiments of the present disclosure.

Referring to FIG. 5, a first screen 10 which is a character user interface screen according to some exemplary embodiments of the present disclosure is illustrated.

According to some exemplary embodiments of the present disclosure, at least one variable 11 to 14 related to the first screen 10 may be displayed in the first screen 10.

For example, a first variable 11 related to TIME, a second variable 12 related to CODE, a third variable 13 related to IDENTITY, and a fourth variable 14 related to MSG may be displayed in the first screen 10. However, the present disclosure is not limited thereto, and variables may be displayed in the first screen 10, which are more or less than the variables listed above.

Meanwhile, the processor 110 of the computing device 100 may recognize at least one reference variable into which at least one object is input among one or more variables 11 to 14 related to the first screen 10 as described above in step S110 of FIG. 2.

Specifically, the processor 110 may recognize one or more variables 11 to 14 related to the first screen 10. In addition, the processor 110 may recognize a variable changeable through a user input among one or more variables 11 to 14 related to the first screen 10 as at least one reference variable.

More specifically, the processor 110 may recognize one or more reference variables by analyzing a program code related to the first screen or recognizing texts displayed in the first screen.

For example, the processor 110 may recognize a second variable 12 related to a code which is a variable changeable through a user input and a third variable 13 related to the ID, among one or more variables 11 to 14 related to the first screen 10 through the above-described method as at least one reference variable.

FIG. 6 is a diagram for describing an example of a graph showing a call relationship according to some exemplary embodiments of the present disclosure.

Referring to FIG. 6, information on a call relationship according to some exemplary embodiments of the present disclosure may include a graph 20 showing a call relationship.

Specifically, the graph 20 may show a call relationship of a specific reference variable and a specific object, and a specific screen corresponding to the specific reference variable and the specific object, or a specific program.

Meanwhile, the processor 110 of the computing device 100 may recognize one or more reference variables, and then generate call relationship information of each of one or more reference variables, as described in step S120 of FIG. 2.

Specifically, the processor 110 may generate the call relationship information by recognizing a subsequent screen (or program) converted when the specific object is input into a specific reference variable related to the first screen which is the character user interface screen.

For example, the processor 110 may recognize a second screen 23 switched when a first object is input into a first reference variable related to a first screen 21. In addition, the processor 110 may generate call relationship information including a graph 20 showing a call relationship of the first reference variable, the first object, and the second screen.

That is, as shown, the graph 20 may have a structure of connecting each of the first screen 21, the first reference variable, the first object 22, and the second screen 23. Further, the graph 20 may show a call relationship in which the second screen 23 is output when the first object is input into the first reference variable displayed in the first screen 21. However, the present disclosure is not limited thereto.

The processor 110 of the computing device 100 may recognize a common reference variable which is commonly referenced among one or more reference variables by using the call relationship information.

Specifically, the processor 110 may recognize the common reference variable by recognizing a subsequent screen (or program) converted when each of two or more specific objects is input into the specific reference variable related to the first screen which is the character user interface screen.

Accordingly, the user may easily switch the menu generated based on the main frame by using the menu model of the present disclosure into the menu usable in the web environment. That is, the menu model may increase productivity of a menu switching operation between different program environments.

FIG. 7 is a diagram for describing an example of a method for determining a menu selection variable in a program code related to a character user interface according to some exemplary embodiments of the present disclosure.

Referring to FIG. 7, a program code 30 related to a character user interface may include a code related to the common reference variable and a code related to a plurality of objects input into the reference variable.

Meanwhile, the processor 110 of the computing device 100 may determine at least one menu selection variable among the common reference variables.

Specifically, when each of a predetermined number (e.g., 3) or more objects is input into the first reference variable 31 recognized as the common reference variable, the processor 110 may recognize whether each input object is switched to each of a predetermined number or more screens corresponding to a predetermined number or more objects, respectively. In addition, when each of the predetermined number or more objects is input into the first reference variable 31, if the processor 110 recognizes that each input object is switched to each of the predetermined number or more screens corresponding to the predetermined number or more objects, respectively, the processor 110 may determine the first reference variable 31 as the menu selection variable.

For example, when it is assumed that a predetermined number used for determining the menu selection variable is 3, the processor 110 may recognize that a first object 32, a second object 33, and a third object 34 are switched to screens corresponding to the first object 32, the second object 33, and the third object 34, respectively, and respective corresponding programs are executed when each of the first object 32, the second object 33, and the third object 34 are input into the first reference variable 31 which is the common reference variable through the program code 30 related to the character user interface. In this case, the processor 110 may determine the first reference variable 31 as the menu selection variable. However, the present disclosure is not limited thereto.

FIG. 8 is a diagram for describing an example of a menu model according to some exemplary embodiments of the present disclosure.

According to some exemplary embodiments of the present disclosure, the computing device 100 may generate a menu model 40 that may switch a menu function generated based on various mainframe environments into the web environment. Here, a method for generating the menu model 40 by the processor 110 of the computing device 100 is described with reference to FIGS. 3 and 4, so a detailed description is omitted.

The menu model according to some exemplary embodiments of the present disclosure may be a model to which a specific menu selection variable, a specific object input into the specific menu selection variable, and a specific operation (e.g., a switched screen or an executed program) executed when the specific object is input into the specific menu selection variable are mapped.

For example, referring to FIG. 8, the menu model 40 may be a table type model including a menu selection variable column 41, an input object column 42, an operation column 43 executed when the object is input into the menu selection variable, and a description column 44 for a menu. However, the present disclosure is not limited thereto.

The menu model 40 of the present disclosure may be used for converting a menu function generated based on a main frame environment into a menu function usable in a web environment. For example, the menu model may be used for converting a typing based menu selection function (main frame environment) into a click based menu selection function or a list based menu selection function (web environment). However, the present disclosure is not limited thereto.

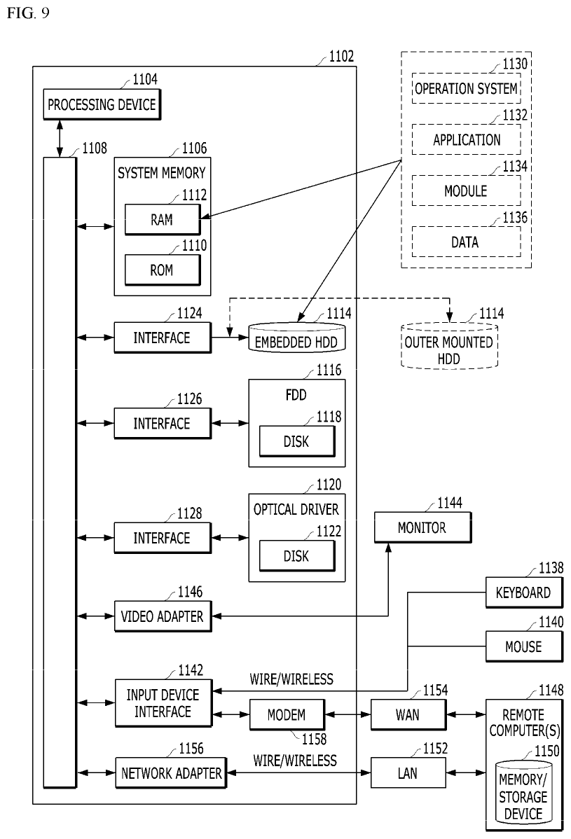

FIG. 9 is a simple and general schematic diagram illustrating an example of a computing environment in which the exemplary embodiments of the contents of the present disclosure are implementable.

The present disclosure has been generally described in relation to a computer executable command executable in one or more computers, but those skilled in the art will appreciate well that the present disclosure is combined with other program modules and/or be implemented by a combination of hardware and software.

In general, a module in the present specification includes a routine, a procedure, a program, a component, a data structure, and the like performing a specific task or implementing a specific abstract data type. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium.

The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a Random Access Memory (RAM), a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally includes all of the information transport media, such as a carrier wave or other transport mechanisms, which implement a computer readable command, a data structure, a program module, or other data in a modulated data signal. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable storage media, the HDD, the portable magnetic disk, and the portable optical media, such as a CD, or a DVD, are mentioned, but those skilled in the art will well appreciate that other types of computer readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a server computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication server on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. A term “machine-readable medium” includes a wireless channel and various other media, which are capable of storing, holding, and/or transporting a command(s) and/or data, but is not limited thereto.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A method for generating a menu model of a character user interface, the method comprising:
recognizing one or more reference variables into which one or more objects are input among one or more variables related to a first screen;
generating call relationship information of each of the one or more reference variables;
recognizing a common reference variable which is commonly referenced among the one or more reference variables by using the call relationship information; and
generating a menu model by using at least one menu selection variable included in the common reference variable.

2. The method of claim 1, wherein the recognizing of one or more reference variables into which one or more objects are input among one or more variables related to the first screen includes
recognizing the one or more variables related to the first screen, and
recognizing a variable changeable through user input among the one or more variables related to the first screen as the one or more reference variable.

3. The method of claim 1, wherein the generating of the call relationship information of each of the one or more reference variables includes
recognizing a second screen switched when a first object is input into a first reference variable related to the first screen, and
generating the call relationship information including a graph showing a call relationship of the first reference variable, the first object, and the second screen.

4. The method of claim 1, wherein the generating of the call relationship information of each of the one or more reference variables includes
recognizing a first program executed when the first object is input into the first reference variable related to the first screen, and
generating the call relationship information including a graph showing a call relationship of the first reference variable, the first object, and the first program.

5. The method of claim 1, wherein the recognizing of the common reference variable which is commonly referenced among the one or more reference variables by using the call relationship information includes
when each of two or more objects is input into the first reference variable related to the first screen, recognizing whether each input object is switched to each of two or more screens corresponding to two or more objects, respectively, and
when each of two or more objects is input into the first reference variable, if it is recognized that each input object is switched to each of two or more screens corresponding to two or more objects, respectively, recognizing the first reference variable as the common reference variable.

6. The method of claim 1, wherein the generating of the menu model by using at least one menu selection variable included in the common reference variable includes
when each of a predetermined number or more objects is input into the first reference variable recognized as the common reference variable, recognizing whether each input object is switched to each of a predetermined number or more screens corresponding to a predetermined number or more objects, respectively, and
when each of the predetermined number or more objects is input into the first reference variable, if it is recognized that each input object is switched to each of the predetermined number or more screens corresponding to the predetermined number or more objects, respectively, determining the first reference variable as the menu selection variable.

7. The method of claim 1, wherein the generating of the menu model by using at least one menu selection variable included in the common reference variable includes
when the at least one object is input into the at least one menu selection variable, recognizing at least one switched final screen or at least one executed final program, and
generating the menu model by mapping at least one menu selection variable and at least one object, and information on the at least one final screen or information on the at least one final program.

8. The method of claim 7, further comprising:
recognizing at least one word on a screen related to the at least one menu selection variable;
recognizing a similarity value between the at least one word and the at least one object;
determining a first word having a largest similarity value for a first object among one or more objects as a menu description word of the first object; and
mapping the first object and the menu description word when generating the menu model.

9. The method of claim 1, wherein the generating of the menu model by using at least one menu selection variable included in the common reference variable includes
when the at least one object is input into the at least one menu selection variable, recognizing whether a subsequent operation related to the at least one object is determined by a server, and
when the subsequent operation related to the at least one object is determined by the server, generating the menu model by using the menu selection variable and information on the subsequent operation related to the at least one object.

10. The method of claim 9, wherein when the subsequent operation related to the at least one object is determined by the server, the generating of the menu model by using the menu selection variable and the information on the subsequent operation related to the at least one object includes
when the subsequent operation related to the at least one object corresponds to the at least one object, generating the menu model by mapping the at least one menu selection variable, the at least one object, and the information on the subsequent operation corresponding to the at least one object.

11. The method of claim 10, wherein the information on the subsequent operation corresponding to the at least one object includes
when the at least one object is input into the at least one menu selection variable, at least one of the information on at least one switched final screen or the information on at least one executed final program.

12. The method of claim 9, wherein when the subsequent operation related to the at least one object is determined by the server, the generating of the menu model by using the menu selection variable and the information on the subsequent operation related to the at least one object includes
when the subsequent operation related to the at least one object does not correspond to the at least one object, generating the menu model by mapping the at least one menu selection variable, the at least one object, and the information on an operation of transmitting the at least one object to the server.

13. A computer program stored in a computer readable storage medium,
wherein the computer program includes commands which cause a processor of a computing device for generating a menu model to perform the following steps, the steps comprising:
recognizing at least one reference variable into which at least one object is input among one or more variables related to a first screen;
generating call relationship information of each of the one or more reference variables;
recognizing a common reference variable which is commonly referenced among the one or more reference variables by using the call relationship information; and
generating a menu model by using at least one menu selection variable included in the common reference variable.
